(19) United States
(12) Patent Application Publication
(10) Pub. No.: US 2006/0259461 A1
(43) Pub. Date: Nov. 16, 2006

(54) Method and system for preserving access to deleted and overwritten documents by means of a system recycle bin

(76) Inventor: Rajesh Kapur, Scarborough (CA)

Correspondence Address: MILLER THOMPSON, LLP, Scotia Plaza, 40 King Street West, Suite 5800, TORONTO, ON, M5H 3S1, CA

(21) Appl. No.: 11/248,319

(22) Filed: Oct. 13, 2005

(30) Foreign Application Priority Data
May 16, 2005 (CA) 2,506,756
Sep. 22, 2005 (GB) 0519365.1

(51) Int. Cl. G06F 17/30

(52) U.S. Cl. 707/2

(57) ABSTRACT

A method for recycling intentionally, and or unintentionally deleted or overwritten document data within a system, wherein said document data is stored in a system filestore associated with a system database containing reference data pointing to the document data in the filestore, the method comprising the steps of determining that a delete and or overwrite command has been issued; recording the reference data prior to and or after the deleting or updating of the reference data; identifying and storing document data deleted to a separate empty filestore; and recycling document data required by the user back to the system database and filestore, as necessary depending on user requirements manipulating the data, to provide the document in the required way and version requested by the user.

### FIELD OF INVENTION

The present invention relates to a method, system, for storing, preserving access and retrieving documents and associated metadata in a Document management system in regards to both the delete and or overwrite of a Document version. It also relates to the storage preservation of access and retrieval of documents deleted, archiving of documents, and associated metadata to disk storage and/or to add these documents and associated metadata to a secondary archive document management system.

### BACKGROUND OF THE INVENTION

The present invention also relates to a method and system for capturing and recovering documents or versions of intentionally or unintentionally deleted and or overwritten within a document management system.

### BACKGROUND OF INVENTION

Many large companies use document management software to provide a streamlined and efficient way of managing day to day business activities. The purpose of the software is to help companies keep track of large volumes of documents in an organised way. Thus, the documents can be easily stored, found and retrieved. In some cases, there may be more than one version of a particular document. In these circumstances, version control is an issue of particular importance. Version control is an aspect of most document management systems that enables different people to have shared access to a document. In addition to having shared access, the individuals have a right to individually modify the shared documents.

As an example, document management software may be used in a large engineering company that has many versions of the same part. When a part is ordered by a client, the correct part version needs to be found by the engineering company.

Document management systems typically include a system database associated with a filestore. The filestore stores actual documents while the system database stores reference information that points to the document within the filestore. The system database also typically stores supplementary document information regarding each document (such as lifecycle, workflow, permissions, attributes stored against etc.). The system also has the concept of object inheritance in regards to documents stored so a document could be of type letter, or of type engineering, both inherited from a standard document, in many cases the document under consideration has different attributes or metadata attached to it depending on what type of document is being considered.

Documentum™ is an example of a document management system that comprises three different layers (or technologies) located on top of a server based operating system such as Unix™ or Windows 2000™, a system database, and a filestore.

The Documentum™ layers are located on top of a database and the layers serve Documentum™ client interfaces. The reference information (i.e. the information pointing to the physical document data) and the supplementary document information (i.e. the attributes of the types of the documents stored, and any metadata associated) are stored in the database. The actual physical data is stored in a filestore on either the server, a Storage Area Network (SAN) or filer pointed to by the server.

As part of the management of a document management system, the system database and filestore continue to grow in size. This is positive and desirable for the business as a whole as the company's data is kept safe. From time to time documents are in the normal course of events deleted from the system database and filestore, or a particular version of the document gets deleted, when it is overwritten the user storing the new document as the same version. However, in some cases the deleting or overwriting of a document gets done in error, with valuable information within the document or the previous version thereof being lost in the process. When this happens it is desirable for the user to be able to get his original document back. However, often, by the time the user realises that he needs his original document back; the document management system has run a standard clean up routine that makes it effectively impossible to retrieve the deleted or overwritten file. Clean up routines are required because if the system database is not cleaned up every so often inconsistencies can arise in the system database information, which can also lead to corruption of the system. A second, scenario also exists, in that, in some cases the amount of data in this Document Management system continues to grow. Now, at other times, it would be advantageous, to be able to delete old version, or hive off data, as systems seem to grow and grow, backups even start to take hours and sometimes days this affects the availability of the system and is generally undesirable when attempting to a keep business going.

There is no current known method which allows a authorised user a method, system to recover both the documents that get mistakenly or maliciously deleted or overwritten or in the case of housekeeping to allow intentional deletion of files in order to hive off or archive data to either a traditional storage device or to a secondary disk media (i.e. disk drive, backup tapes and or a secondary filestore etc. . . . ) and or to a secondary archive system on request, the file recoverable at a later point back to the primary system if required.

A deleted document refers to any or all versions of a document selected to be deleted, it is important to note here that the physical file is not deleted in the first case, but certain metadata associated with the representation or image of the file get removed by clean up jobs.

A overwritten document refers to a user “checking out” the document and saving the document as the same version (thereby losing the previous content of the document) checking in by accident or by design as the same version of the document as the document that is being modified, thereby the prior document, is overwritten. Sometimes this prior work is still required, especially if the document is being worked on by two people and one person looses his work because a second person removes a clause, or, the part is slightly different in a new model of car. If the process is completely reversed the new document can be lost. The user therefore has the option through this invention to return the document as a new document of the same name, or indeed to replace the document that replaced it.

A Document within a Document Management System is based on both a metadata representation and an actual physical file component.

It is an object of the present invention to provide a mechanism to trap , record, store and recover to the original system, or secondary system (document management system) on request, the document and associated metadata whether the file was unintentionally deleted or overwritten or intentionally deleted for archive purposes on user request.

According to one aspect of the present invention, there is provided a method for recycling intentionally, and or unintentionally deleted or overwritten document data within a system, wherein said document data is stored in a system filestore associated with a system database containing reference data pointing to the document data in the filestore, the method comprising the steps of determining that a delete or overwrite command has been issued; recording the reference data prior to and or after the deleting or updating of the reference data; inserting the recorded reference data in a set of access-preservation tables; inserting other salient information connected with the before delete reference data contained within system tables into a second set of access preservation tables; providing a set of combination tables to point to the deleted/overwritten document data within the filestore; identifying and storing document data deleted to a separate empty filestore; and recycling document data required by the user back to the system database and filestore, as necessary depending on user requirements manipulating the data.

According to another aspect of the present invention, there is provided a method for recycling deleted or overwritten document data within a system wherein said document data is stored in a system filestore associated with a system database containing reference data pointing to the document data in the filestore, the method comprising the steps of determining that a delete or overwrite command has been issued; recording the reference data prior to, and or after the deleting or updating of the reference data; inserting the recorded reference data in a set of access-preservation tables; inserting other information connected with the before delete reference data contained within system tables into a second set of access preservation tables; providing a set of combination tables to point to the deleted/overwritten document data within the filestore; identifying and storing document data deleted to media and or to a empty filestore; and recycling document data required by the user back to the system data base to and or to a secondary archive system database and filestore, as necessary, depending on user requirements manipulating the data, to provide the document in the required way and version requested by the user.

The invention has the advantages that the documents and versions of that are intentionally or unintentionally deleted can on requirement be recycled and returned to the authorised user, together with any salient information stored against that document if required. The information could also be hived of to storage media or inputted into a second archive/delete system. Document management systems are fairly recent and do not have this facility.

According to another aspect the present invention provides a system for preserving access to deleted or overwritten document data, by means of a system recycle bin, comprising a database for storing reference information and supplementary document information; at least one trigger for catching and recording reference data that has been deleted and/or updated to this database from the document management system tables; at least one access preservation table for storing salient reference data in this database the access preservation data that has been deleted and/or updated; and at least one stored procedure to combine data captured in the at least one access preservation table, into the at least one combination table; at least one combination table being operable to point to the encrypted document in the filestore to a secondary filestore to store deleted and or updated documents; at least one secondary filestore or storage media to store a copy of the deleted and or updated documents.

According to further aspects of the present invention there is provided computer program code, optionally provided on storage medium, which when loaded onto a computer will cause the computer to function as a system in accordance with the method or apparatus of any of the amended claims.

Preferably, the reference data is contained within system tables in the system database, and wherein the method comprises using a recording step which comprises the step of recording reference data from the system tables. Preferably, the system in response to a delete/overwrite command deletes reference data from some system tables and updates reference data to other tables.

Preferably, the system comprises a document management system. Preferably, the system comprises of a Documentum document management system. Preferably, the system, in response to a delete/overwrite command, deletes core reference data from first and second system tables and updates reference data from a third system table. Preferably, the system comprises a Documentum document management system, and wherein the first system table comprises a dm_sysobject_s table, the second system table comprises a dm_sysobject_r table, and the third table comprises a dmr_content_r table.

Preferably, the core reference data comprises object identification data from the first table, version identification data from the second table, and a parent identification within the third table, wherein the parent identification can be joined to a fourth table which points to the document data in the system filestore. Preferably, the system comprises a Documentum document management system and wherein the fourth table comprises a dmr_content_s table.

Preferably, the recording step comprises using a database trigger. Preferably, the recording step comprises recording the reference data using at least one Oracle trigger. Preferably, the main recording step comprises recording the reference data using a first Oracle trigger associated with the first table, a second Oracle trigger associated with the second table, and a third Oracle trigger associated with the third table.

Preferably, for the first set of access-preservation tables, the set comprises a first access-preservation table to receive reference data recorded from the first system table, a second access-preservation table to receive reference data recorded from the second system table, and a third access preservation table to receive reference data recorded from the third system table, together with a date timestamp. Preferably, the method further comprises the step of using the reference data from the first set of access preservation data to obtain supplementary document information, related to the deleted/overwritten document, from system tables, together with a date timestamp.

Preferably, this supplementary information includes a record of the complete reference information for each system table that holds any information pertaining to a document, before it is deleted, to be placed into a second set of access preservation tables. Preferably, the recording step used for obtaining information into the second set of access-preservation tables includes, using database triggers and SQL commands. Preferably, the recording step used for obtaining information into the second set of access-preservation tables includes, using Oracle triggers and Oracle SQL commands.

Preferably, the method comprises keeping a record of the recording process with regards to recording reference data in each of the system tables concerned, and for especially in regard to each document being deleted and/or overwritten at a later stage. Preferably, the recording steps to gain the supplementary data and recording process comprise recording prior to the system executing a method that cleans the system tables to prevent access to supplementary document information for deleted/overwritten documents from the system tables.

Preferably, a subset of the supplementary document information is also combined into combination tables using data recorded in the first set of access preservation tables this includes, but is not limited to information selected from the following group: a name of the document deleted or overwritten, a folder within the system database from which the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date timestamp that the document was deleted/overwritten.

Preferably, the method further comprises combining the first set of access-preservation tables and some supplementary document information from the system into a combined table. Preferably, the method further comprises combining the first set of access-preservation tables and a subset of the supplementary document information from the system into two combined tables one for deletes and one for overwrites.

Preferably, the combining step comprises combining prior to the system executing a method that cleans the system tables to prevent access to supplementary document information for deleted/overwritten documents from the system tables. Preferably, the system comprises a Documentum document management system, and wherein the clean method is carried out by a dm_clean routine. Preferably, the method further comprises the physical file path and file on the filestore being calculated and copied to a safe location, and prior to another documentum job to clean the filestore.

Preferably, this safe location is an empty storage area with a similar path in another drive location. Preferably, this safe location is updated into the combination tables. Preferably, the method comprises that on a request for a lost document; the information can be inserted, updated back into the original database system tables, through a manual method. Preferably, the manual method comprises using the combination tables to determine relevant data required by the user.

Preferably, the relevant data required is used as an input into at least one database stored procedure which references the first and second set of access preservation tables and combination table. Preferably, the relevant data required is used as a input into two database stored procedures, one for re-inserting information regarding the recycling of a deleted document, the second for inserting information regarding the recycling of an overwritten document. Preferably, the first of these procedures to carry out SQL commands to all the database system tables required, with the reference data prior to the delete of the document, depending upon user input recycling either a single version, or all versions of a document.

Preferably the second of these procedures to carry out SQL commands to all the database system tables required, with the reference data prior to the overwrite of the document, depending upon user input, recycling either as a completely new document, or the ‘new’ current version of the document in the system. Preferably, the method also comprises copying the physical file back from the storage delete filestore to the main filestore.

Preferably, method comprises the viewing the combination tables to select the relevant document deleted or overwritten required to be re-inserted through some control software. Preferably, the control software, takes as input, the object identified in the combination tables, the user option and uses two database stored procedures to access the information in the first, second set of access preservation tables and combination tables to restore the before delete/overwrite reference information to the relevant system tables. Preferably, the control software also issues a command which copies the file in the deleted files filestore back to the system filestore.

Preferably, the control software has a user friendly interface. Preferably, the control software is written in Visual Basic. Preferably, the recording, inserting, updating and providing steps are executed by the execution of Oracle software code. Preferably, the recording, inserting, updating and providing steps are executed by the execution of SQL Server software code.

Embodiments of the invention will hereinafter be described, with reference to the accompanying drawing, in which:

### DRAWINGS

FIG. 1 is a schematic diagram of a system describing a document management system encompassing a system recycle bin according to a first embodiment of the present invention which allows the capture and on user request return of relevant reference and document data at the exact time it is inserted, deleted or updated.

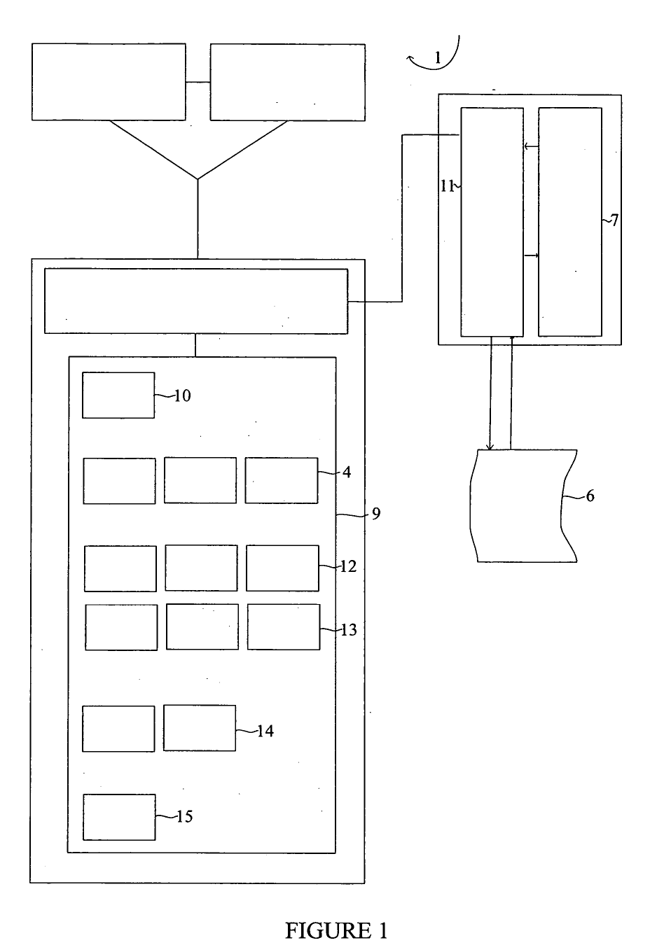

### DESCRIPTION OF THE INVENTION

The system 1 is made up of a system database 9 including a number of system tables 10 and a filestore 11. The actual physical data, i.e. the document data files themselves are stored in the filestore 11, in this case shown as a storage area network (SAN). Reference information about the data stored in the filestore, i.e. information pointing to the physical document data and supplementary document information, i.e. the attributes of the types of documents stored are stored in the system database 9. The data sent to the system tables 10 is in the form of Metadata.

As is known from conventional databases and document management systems are similar, metadata contains information sufficient to enable a system to identify each file stored in the filestore 11 sufficiently to enable authorised personnel to retrieve, protect and carry out the disposition of the files in the filestore 11. This information may include items such as: place of origin, file code/identification, a key for retrieval of the physical file etc. Each time a file is edited, metadata is generated. The metadata is used to update information in the system tables 10 corresponding to the file held in the system database. Therefore, if a document is added, updated or deleted, the metadata will provide information of this to the system database of the system 1 to enable the changes to be made.

The system database 9 shown comprises a system table 10 representing one such system table of many, newly added access preservation tables 12 and 13 to store transaction information, database procedures 14 to implement logic programs and the database triggers 4 recording transactions e.g. update, delete and insert, and a combination transaction table 15. Also depicted is a storage media 6 and a secondary empty filestore 7.

In one embodiment triggers 4 are added to the relevant Documentum tables 10 for the Documentum Document Management System and they automatically fire to capture the salient information needed to retrieve the pointer information to the physical data for the file by running a couple of oracle stored procedures or sql command statements, to a first set of core access-preservation tables 12. The first set of access preservation tables 12 can be populated in a number of ways depending on the data stored one such embodiment for the documentum system uses the dm_sysobject_s table to obtain the core reference information including the parent information and so the parent information does not need to be obtained from the dmr_content_r table. In an alternative embodiment which can also be used to capture the core reference information described in co-pending Patent Application GB 0516374.6, CA 2,504,070 the dmr_content_r table is used to obtain the Parent information.

The second set of access preservation tables 13 are filled by means of triggers 4 attached to the documentum tables with all other salient information concerning the deleted object (e.g. a record of the reference data in dmr_content_s for each document/object that is deleted, the type information etc). This information is stored in secondary access preservation tables, prior to the dm_clean job. The information in the dmr_content_s table, for example is not deleted, or updated when an object is deleted; however, this is information that could be lost once dm_clean is run. Should it become necessary to restore the object data in the system tables to the state prior to the data being deleted, then the lost information in dmr_content_s needs to be present once more.

A typical Documentum system database has a number of system tables that store reference information and supplementary document information. These tables include (but are not typically limited to) the dm_sysobject_s table (first table), which stores object IDs for the documents; the dm_sysobject_r table (second table) which stores, inter alia, version IDs for documents; the dmr_content_r table (third table) which stores, inter alia, parent ID needed to find the pointer to the document within the filestore; and the dmr_content_s table (fourth table), which stores an r_object_ID that, together with the parent_ID, determines the pointer to the location of the document within the filestore.

According to one embodiment of the invention when a document is deleted/overwritten; the relevant reference core data from the first two tables is deleted, and the relevant core reference data from the third table (the parent ID) is updated to a Null.

According to this embodiment of the invention, at least one, and preferably three core Oracle triggers are used to catch and record the core reference data that was deleted and/or updated to the core first set of access-preservation tables.

This reference data is then inserted into the first set of access-preservation tables (preferably one corresponding to each of the first three system tables), and the access-preservation data combined with a fourth system table to provide a combination table 15 having the salient information to calculate the deleted/overwritten document within the filestore.

All reference data and supplementary reference data apart from the core data above that is required to “recycle” the document on user request is inserted into a second set of access preservation tables; using database triggers, and Sql commands or stored procedures containing the sql commands. This step can be performed each night, but must be performed before dm_clean is run.

The document in the filestore is calculated and copied to a purpose built initially empty delete filestore for later retrieval and the location stored is updated in the combination table 15.

The method preferably further comprises the step of combining the access preservation tables and a subset of the supplementary document information into a set of at least one combined table. This step is preferably performed before the system executes a cleaning of the system tables, because at least some of the supplementary document information will not be available once a cleaning, such as a dm_clean routine, is run.

In one embodiment, the reference data from the first access preservation tables is used to obtain supplementary document information, related to the deleted/overwritten document, from the system tables to fill combination tables to help the user identify the document required to be retrieved. The core supplementary document information preferably includes, but is not limited to a name of the document deleted or overwritten, a folder within the system database from which the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date that the document was deleted/overwritten.

The method preferably further comprises the step of recording and preserving all before information in the said system tables and all related system tables using oracle triggers and sql commands within database procedures with regards to each deleted/overwritten object together with a date timestamp into a secondary set of access-preservation tables.

The triggers on each table in the documentum database required also record the changes on update, insert, delete to access-preservation tables to a transaction table 15 for all changes on all tables.

So that this information can be restored using sql commands back into the system tables where necessary in reverse-order later if needed, thereby recycling it, this even after dm_clean runs (as data has been preserved in a second set of access-preservation tables).

The method also calculates the whereabouts of the file matching the deleted document on the filestore 11 and copies it to a safe location (secondary filestore 7) together with its full path, storing this location, so it can be returned if necessary to the original filestore 11, if the document is to be restored.

This invention captures the data and the information from the filestore 11 in a kind of a “system recycle bin”. On request the data is re-input in reverse order to the database system tables, manipulating it where necessary depending on the user options chosen using the recorded timestamp. The filestore 11 re-populated with the necessary file.

The transactions made on the three core tables dm_sysobject_s, dm_sysobject_r, and dmr_content_r during delete of the file by the system commands can be reversed by Sql commands encapsulated within stored procedures. Furthermore a row added to dmr_content_s if subsequently found missing. Likewise all supplementary information can be restored.

Using the base option it will appear to the user that the file was never deleted, or overwritten (In the case of an overwritten document the user must be informed that the recycling of the overwritten document will replace the version of the document that overwrote it).

In an alternative embodiment extra options are provided which allow the user to retrieve the old document as the current version, or as a, totally new document, in order not to loose the document that overwrote the one the user requires. In this case the data retrieved from the set of access-preservation tables 12 and 13 is manipulated before adding it to the system database tables to provide the necessary result.

The latest version of a document is usually the current version in Documentum.

The method preferably comprises searching and viewing the information in the combination table, through a software interface which provides a Gui front-end. Upon selection of this information and retrieval option it would run database stored procedures that automatically restore the data within the database system tables and also copy over the file from the safe location back to the main filestore 11, using the transaction 15 and access preservation tables 12, 13.

In one embodiment, the data location within the filestore 11 at which a document is located is obtained by combining the parent ID from the third table with the r_object_ID from the fourth table to obtain the data ticket (i.e. the pointer) along with the storage ID which can be used to find the file path of the document on the filestore.

This pointer information can then be translated through commonly available Documentum support notes. The Data Ticket and the storage_id (pointer info) are two pieces of data that need to be obtained to help retrieve the document's physical file. The other information required is the r_object_id and the parent_id.

The actual path and filename are typically encrypted within the filestore to protect the document from unauthorized access. To decrypt, support note 310 is used and the parent_id taken from the combination tables described further below; before dm_clean is run, the parent ID is plugged into the Documentum APIs shown on the note through the API interface in Documentum Administrator. For example:
apply,c, 090106d450cgbs3b, GET_PATH
next,c,q0
get,c,q0,result

This gives you the path of the file on the content store (but only works before dm_clean is run).

As described below, another Documentum support note can also be used to calculate the full file path and name of the document stored on the server. This is done using the r_object_id, storage_id and Data_ticket (all values contained in the combination tables This alternate calculation of the file path and name can be compared with the above calculation using note 310 to increase the probability that the correct file path and name are known. Once dm_clean has been run, the note 310 calculation will not work, but the alternate calculation will function to find the exact place on the server or backup tape at which a deleted file resides. The method of the present invention can then be used from the time of successful comparison of the two name and path calculations. i.e. by running the procedures below automatically through either a Cron/or Veritas job.

When an object or document is deleted or overwritten, the parent_id of the document is updated and set to Null. Once this occurs there is no way to link the dmr_content_r table to the dmr_content_s table. The purpose of the recording of reference information was, inter alia, to ensure that the parent ID was recorded in order to get storage location and data ticket.

Below, there is shown sample code implementing a small portion of the invention, more columns of data are required than those shown if the document is to be recycled. A column of data in this case would represent in the case of the dm_sysobject_s the r_object_id, object_type i.e. the info contained within. The code shows the process of recording the data from the core tables.

On reversing the process the whole row of data within the dmr_content_r table it appears that the value of the parent_ID set to Null would have to be placed back, however, the whole row may be missing especially after the dm_clean method has run and have to be re-inserted entirely using an insert statement.

Code is given for both Oracle and SQL Server (For Delete is for older versions). The invention can be implemented in a multi-document management system embodiment. The invention can be implemented in a multi-database embodiment.

Oracle
create or replace trigger capture_del_s_trigger
before delete on dm_sysobject_s
for each row
Begin
kapurture_del_s(:old.r_object_id,:old.r_object_type,:old.-
object_name);
EXCEPTION
when others then
RAISE;
END
create or replace trigger capture_i_trigger
before update on dmr_content_r
for each row
Begin
kapurture_del_i(:old.r_object_id,:old.-
parent_id);
EXCEPTION
When others then
RAISE;
END;
/
Create or replace trigger capture_del_r_trigger
before delete on dm_sysobject_r
for each row
Begin
kapurture_del_r(:old.r_object_id,:old.r_version_label,:old.-
i_folder_id);
EXCEPTION
when others then
RAISE;
END;
/ then Sql Server:-
create trigger After Delete -- FOR Delete
As
if exists (insert into capture_del_r_table values (r_object_id,
r_version_label, i_folder_id)
select r_object_id, r_version_label, i_folder_id from deleted where
r_object_id in (select r_object_id from deleted)
go
create trigger capture_i_triggeron dbo.dmr_content_r
After Update -- FOR Update
as
if exists ( insert into capture_i_table values (r_object_id, parent_id)
select r_object_id, parent_id from deleted where
r_object_id in (select r_object_id from deleted)
)go
create trigger capture_del_s_trigger
on dbo.dm_sysobject_s After Delete -- FOR Delete
as if exists ( insert into capture_del_s_table values (r_object_id,
r_object_type, object_name,date_saved)
select r_object_id, r_object_type, object_name,getdate( ) from
deleted where r_object_id in (select r_object_id from deleted)
)
go

In the dm_sysobject_{'}s and dm_sysobject_{'}r tables, a “before row delete” is preferably used, meaning the data is about to be deleted is captured. For the dmr_content_r table, a “before update row” is preferably used, meaning that the data to be updated is captured. This ensures that all salient and/or relevant information is captured.

It will be appreciated that an “after row delete” and “after row update” could also be used and are comprehended by the invention. In such a case, the old values are captured immediately upon the deletion or update.

The reference data is trapped (i.e. recorded) and inserted into three tables (again these tables would need to be extended to capture all the columns for the purposes of re-cycling):

create table capture_i_table (r_object_id varchar2(16),
parent_id varchar2(32), date_saved date)/
create table capture_del_s_table (
r_object_id varchar2(16),
r_object_type varchar2(32),
object_name varchar2(255),
date_saved date)
/ create table capture_del_r_table (
r_object_id varchar2(16),
r_version_label varchar2(32),
i_folder_id varchar2(16))
/

More tables for extra data need to be added to these tables, together with a date timestamp, in order for the method to record the salient supplementary reference data from the system tables, in regards to “recycling” or restoring the document back into the system. The procedures, given the names RKapurture_del_data.plb and RKapurture_upd_data.plb, then are used to combine the three access-preservation tables with the dmr_content_s table to produce the combination tables and to get the all important data_ticket value which must be converted to a char using to_char(data_ticket) as well as combining other data.

Additionally, further oracle database stored procedures that reference the access-preservation tables, the combined tables are necessary to capture all the supplementary and reference information in the system tables before the method dm_clean runs into access-preservation tables.

Further procedures taking input parameters these being the object to restore and which option the user requires to restore the information captured, back to the database system tables that form the documentum document management system, using information stored in the transaction table.

The combination tables could take the form of a single table for both deletes and overwrites. However, it is preferred that there be a combination table for deletes and one for overwrites, (again these tables contain here only a subset of the columns to necessary to ensure recycling).

create table capture_del_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/
create table capture_upd_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/

Once the storage_id, data_ticket, r_{'}object_id, parent_id are available in the above tables the method of the present invention is preferably every night and just before dm_clean runs. This will ensure that all of the necessary reference data is captured.

The following is the “alternate” process referred to above for calculating the file path and name. Take the storage_id obtained and use it as the r_object_{'}id into the table dm_store_s. This should give you the filestore concerned (there could be more than one filestore, which collectively act as the “filestore” for the document management system. The path of the filestore can be found through the Documentum administrator.

Part of the file path on the filestore is stored as a hex code. The first part of this hex code is usually contained within the r_object_id of the deleted row corresponding to the deleted document. The remainder of the filepath can be obtained by converting the data_ticket from dec to hex using the dword function on the standard scientific calculator on Microsoft windows, as the support notes will indicate.

For example if you have a data ticket say −2147561899 this converts into 75FECE55 . . . i.e the path to the file could look something like this:
c:\filestore1\documentum\docbase_name\00\06d450\75\FE\CE\55 where 55 is the file name on the server and 0006d450 comes from the r_object_id.

Once the formula for the file paths has been worked out by comparing with the above API method then a plsql routine could even be written to give this automatically.

Once the path is known, the name of the file, the object it relates to and the date, the document that was deleted or overwritten can be retrieved from a copy filestore if it has been cleaned off the original filestore.

It will be appreciated that variations in, and modifications to the embodiments described and illustrated may be made within the scope of this application.

1. A method for recycling deleted or overwritten document data within a system wherein said document data is stored in a system filestore associated with a system database containing reference data pointing to the document data in the filestore, the method comprising the steps of:
(a) determining that a delete or overwrite command has been issued; recording the reference data prior to, and or after the deleting or updating of the reference data;
(b) inserting the recorded reference data in a set of access-preservation tables;
(c) inserting other information connected with the before delete reference data contained within system tables into a second set of access preservation tables;
(d) providing a set of combination tables to point to the deleted/overwritten document data within the filestore;
(e) identifying and storing document data deleted to media and or to a separate filestore; and
(f) recycling document data required by the user back to the system database and or to a secondary archive system database and filestore, as necessary, depending on user requirements manipulating the data, to provide the document in the required way and version requested by the user.

2. A system for preserving access to deleted or overwritten document data by means of a system recycle bin, comprising:
(a) a database for storing reference information and supplementary document information;
(b) at least one trigger for catching and recording reference data that has been deleted and/or updated to this database from the document management system tables;
(c) at least one access preservation table for storing reference data in this database, the access preservation data that has been deleted and/or updated;
(d) at least one stored procedure to combine data captured in the at least one access preservation table into the at least one combination table;
(e) at least one combination table being operable to point to the encrypted document in the filestore to a secondary filestore to store deleted and or updated documents;
(f) at least one secondary filestore or storage media to store a copy of the deleted and or updated documents.

3. A system as claimed in claim 2, further comprising at least one system table provided in the database for storing the reference data and supplementary document information.

4. A system as claimed in claim 3 wherein the at least one access preservation table corresponds to the at least one system table.

5. A system as claimed in claim 4 further comprising storage identification means for indicating position of storage within the filestore.

6. A system as claimed in claim 2 further comprising at least one transaction table to store all transaction and timing information to be referenced.

7. A system as claimed in claim 6 further comprising at least one data combination means operable to combine the at least one access preservation table and the supplementary document information into the at least one transaction or combination table.

8. A system as claimed in claim 7 wherein said data combination means comprises deleted data.

9. A system as claimed in claim 7 wherein said data combination means comprises updated data.

10. A system as claimed in claim 9 further comprising at least one transaction table to store salient transaction information trapped to be used in the recycling process.

11. A system as claimed in claim 10 further comprising at least one database procedure to store, update, retrieve transaction information within the at least one transaction table.

12. A system as claimed in claim 11 wherein the at least one database procedure is used to copy back, add versions of documents within the system tables, filestore using the at least one transaction table.

13. A method for preserving access to deleted or overwritten document data within a system, wherein said document data is stored in a system filestore associated with a system database containing reference data to point to the document data within the system filestore, the method comprising the steps of:
(a) determining that a delete/overwrite command has been issued recording the reference data prior to the deleting or updating of the reference data;
(b) inserting the recorded reference data in a set of access-preservation tables;
(c) inserting other information connected with the before delete reference data contained within system tables into second set of access preservation tables;
(d) providing a set of combination tables to point to the deleted/overwritten document data within the filestore;
(e) identifying and storing document data deleted to a separate empty filestore; and
(f) reversing out changes using all information preserved in the set of access-preservation tables and combination table for the required document;
(g) copying the file back to the filestore, from a safe filestore as necessary depending on user requirement; and

14. A method as claimed in claim 1, wherein the reference data is contained within system tables in the system database, and wherein the recording step comprises the step of recording reference data from these system tables along with a date timestamp and recording the physical file from the filestore to another location.

15. A method as claimed in claim 1 wherein the reference data in the prior to and or after the deleting or update include static supplementary data in a system database tables in response to a delete/overwrite command is recorded and preserved in a set of access-preservation tables, and combination tables and transaction table before any clean method is run.

16. A method as claimed in claim 1 wherein the reference data in the set of access-preservation tables in response to a retrieval request for a document on searching and selecting the required document from combined table is placed back into the required database system tables using the preserved information in the transaction, combined and access-preservation tables.

17. A method as claimed in claim 15 wherein the supplementary document information includes information selected from the following group: a name of the document deleted or overwritten, a folder within the system database from the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date that the document was deleted/overwritten.

18. A method as claimed in claim 16 wherein the method further comprises combining the access-preservation table and the supplementary document information into a combined table.

19. A document recovery and archival system for connection to a document management system having a filestore and a system database, the document recovery system comprising a replica filestore and or storage media to store the deleted and or overwritten documents, the document recovery system also comprising at least one database table added to the system database to preserve, combine and print filestore and reference metadata captured from the system tables upon a delete and or update command issued in response to a deleted or overwritten document; and at least one procedure to reverse the delete and or overwrite command.

20. A document management system, the document management system containing a document recovery and archival system comprising a replica filestore and or storage media to store the deleted and or overwritten documents, the document recovery system also comprising at least one database table added to the system database to preserve, combine and point to filestore and reference metadata captured from the system tables upon a delete and or update command issued in response to a deleted or overwritten document; at least one procedure to reverse the delete and or overwrite command by manipulating and returning information.
